(19) United States
(12) Patent Application Publication
(10) Pub. No.: US 2017/0339515 A1
(43) Pub. Date: Nov. 23, 2017

(54) WORKPIECE HOLDING SYSTEM

(71) Applicant: FANUC CORPORATION, Yamanashi (JP)

(72) Inventor: Takashi Masakawa, Yamanashi-ken (JP)

(73) Assignee: FANUC CORPORATION, Yamanashi (JP)

(21) Appl. No.: 15/589,272

(22) Filed: May 8, 2017

(30) Foreign Application Priority Data
May 17, 2016 (JP) 2016-098838

(51) Int. Cl. H04W 4/00; B23Q 3/06; B23Q 7/04; B23Q 17/22

(52) U.S. Cl. CPC H04W 4/008; B23Q 17/22; B23Q 3/06; B23Q 7/04

(57) ABSTRACT

In a workpiece holding system, a communication unit performs short-range wireless communication between a control device and a workpiece holding device. That is, at least one of supply of power from the control device to the workpiece holding device and transmission of a command signal for a holding operation or a non-holding operation of a workpiece from the control device to the workpiece holding device is performed between a first communication unit and a second communication unit that make up the communication unit.

### CROSS-REFERENCE TO RELATED APPLICATION

This application is based upon and claims the benefit of priority from Japanese Patent Application No. 2016-098838 filed on May 17, 2016, the contents of which are incorporated herein by reference.

### BACKGROUND OF THE INVENTION

### Field of the Invention

The present invention relates to a workpiece holding system in which a workpiece holding device holds a workpiece of a machine tool.

### Description of the Related Art

A machine tool performs machining on a workpiece held by a workpiece holding device, and therefore a control device of the machine tool and the workpiece holding device are generally connected electrically via cables. Generally, when machining content of the machine tool is changed, the workpiece holding device itself that holds the workpiece needs to be exchanged. Hence, when the machining content is changed, it is necessary to rewire connection between the control device and the workpiece holding device, and such an operation is complicated and burdensome. Particularly when the machine tool performs machining on workpieces in manufacturing of a wide variety of products in small quantities, the workpiece holding device is frequently exchanged, and therefore the operation is even more complicated and burdensome.

Hence, conventionally, cables are not used to perform an operation for holding or not holding a workpiece or an operation for detecting a holding state or non-holding state.

For example, Japanese Patent No. 3218707 discloses that a holding state or a non-holding state is detected based on a change in a gas pressure in response to a holding or non-holding operation when a workpiece is placed in the holding state or the non-holding state by using the gas flowing in the workpiece holding device.

Japanese Laid-Open Patent Publication No. 2002-036047 (hereinafter referred to as JP2002-036047A) discloses a method for easily exchanging a seal member used for a rotary joint, which is inserted into a table surface side of a rotary table of a machine tool in order to supply a pressure fluid, when the seal member is worn away.

### SUMMARY OF THE INVENTION

According to the technique of Japanese Patent No. 3218707, gas piping needs to be attachable and detachable for the purpose of exchanging of the workpiece holding device. In this case, a seal member needs to be used for the attachable/detachable portion. However, there is a concern that repetition of attachment and detachment may cause damage to the seal member, resulting in gas leakage.

According to the technique of JP2002-036047A, the seal member of the rotary joint is scraped and worn away by surroundings during rotation of the rotary table. Therefore, a pressure fluid such as a pressure oil leaks, so that an operation failure of the workpiece holding device may occur. Further, the pressure oil is a consumable and therefore becomes deteriorated.

Thus, in the case that a workpiece is held by using a fluid, maintenance operations are burdensome and costly. Hence, it is desirable to facilitate an operation for change of machining content of a machine tool by devising ways of rewiring connection between the control device and the workpiece holding device.

The present invention has been made in light of the above problem, and an object of the present invention is to provide a workpiece holding system that makes it easy to perform a rewiring operation when machining content of a machine tool is changed.

To achieve the above object, a workpiece holding system according to the present invention includes: a workpiece holding device configured to hold a workpiece of a machine tool; and a communication unit configured to perform short-range wireless communication between a control device and the workpiece holding device to thereby perform at least one of supply of power from the control device to the workpiece holding device and transmission of a command signal for a holding operation or a non-holding operation of the workpiece from the control device to the workpiece holding device.

According to this configuration, the control device and the workpiece holding device are electrically connected via the communication unit in a contactless manner. Consequently, when machining content of the machine tool is changed and the workpiece holding device itself that holds the workpiece is exchanged, it is unnecessary to perform a rewiring operation, and thus it becomes easy to change arrangements. As a result, the present invention is suitably applicable to manufacturing of a wide variety of products in small quantities in which the workpiece holding device must be frequently exchanged.

Further, according to the present invention, preferably, the workpiece holding system further includes a base fixed to the machine tool, and the workpiece holding device is attachable and detachable with respect to the base. In this case, the communication unit includes a first communication unit mounted on the base, and a second communication unit mounted on the workpiece holding device; and at least one of the supply of power and the transmission of the command signal is performed between the first communication unit and the second communication unit. With the above structure, it is only necessary to exchange the whole workpiece holding device with respect to the base when the machining content of the machine tool is changed. Consequently, it is easy to change the arrangements, and it is possible to reduce man-hours for changing the arrangements.

In this case, preferably, the workpiece holding device is supported by the base rotatably about a rotation axis; and the first communication unit and the second communication unit are provided within a range of a predetermined distance around the rotation axis. Owing thereto, it is possible to continue supply of power or transmission of the command signal to the workpiece holding device during rotation of the workpiece holding device. Further, it is possible to attach a device equipped with signal lines or a device with power cables to the workpiece holding device that is a rotating object, and construct the workpiece holding device. As a result, it is possible to avoid occurrence of problems such as deterioration of a pressure oil, an operation failure of the workpiece holding device due to wearing of a seal member or leakage of a pressure fluid, as in JP2002-036047A.

The workpiece holding device may be disposed in the machine tool; the communication unit may include a first communication unit mounted on an automatic transfer device configured to transfer the workpiece, and a second communication unit mounted on the workpiece holding device; and at least one of the supply of power and the transmission of the command signal is performed between the first communication unit and the second communication unit.

With the above structure, since the automatic transfer device side supplies power or transmits the command signal to the workpiece holding device, it is not necessary to provide a power supply (the control device) for the workpiece holding device on the machine tool side. As a result, reduced wiring can be achieved in the machine tool and peripheral devices of the machine tool.

The workpiece holding system may further include a detecting unit configured to detect whether or not the workpiece is held by the workpiece holding device. In this case, the detecting unit transmits a detection result to the control device via the communication unit. With the above structure, the control device side can check whether the workpiece is held or not.

The workpiece holding device may include a clamp mechanism configured to perform a holding operation and a non-holding operation of the workpiece, and a driving unit configured to operate based on power supplied from or the command signal transmitted from the control device and actuate the clamp mechanism. Owing thereto, the control device side can easily control a holding operation and a non-holding operation of the workpiece.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a block diagram showing a workpiece holding system according to the present embodiment;

FIG. 2A is an explanatory diagram of a first example of the workpiece holding system in FIG. 1;

FIG. 2B is an explanatory diagram showing a workpiece holding device of different machining content;

FIG. 3 is an explanatory diagram of a second example of the workpiece holding system in FIG. 1;

FIG. 4 is an explanatory diagram of a third example of the workpiece holding system in FIG. 1; and

FIG. 5 is an explanatory diagram of a fourth example of the workpiece holding system in FIG. 1.

### DESCRIPTION OF THE PREFERRED EMBODIMENTS

A preferred embodiment of a workpiece holding system according to the present invention will be described in detail below with reference to the accompanying drawings.

### Basic Configuration of Present Embodiment

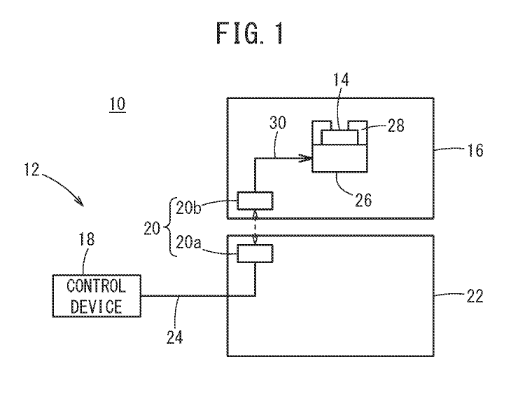

As shown in FIG. 1, a workpiece holding system 10 according to the present embodiment includes a workpiece holding device 16 that holds a workpiece 14 of a machine tool 12, a communication unit 20 that performs short-range wireless communication between a control device 18 of the machine tool 12 and the workpiece holding device 16, and a base 22 that is fixed to the machine tool 12.

The workpiece holding device 16 is detachably supported on the base 22. The communication unit 20 includes a first communication unit 20a that is mounted on the base 22 and a second communication unit 20b that is mounted on the workpiece holding device 16. Short-range wireless communication can be performed between the first communication unit 20a and the second communication unit 20b. In this case, the control device 18 and the first communication unit 20a are electrically connected via first wiring 24.

The workpiece holding device 16 includes a driving unit 26 and a clamp mechanism 28 for holding and not holding the workpiece 14 (for carrying out a holding operation and a non-holding operation with respect to the workpiece 14). In this case, the second communication unit 20b and the driving unit 26 are electrically connected via second wiring 30. In this regard, the driving unit 26 includes an electric actuator (not shown) that actuates the clamp mechanism 28.

The control device 18 supplies power to the workpiece holding device 16 or transmits a command signal for a holding operation or a non-holding operation of the workpiece 14, to the workpiece holding device 16, via the first wiring 24 and the first communication unit 20a. The first communication unit 20a performs short-range wireless communication to supply power or transmit the command signal to the second communication unit 20b. The second communication unit 20b supplies power or transmits the command signal to the driving unit 26 via the second wiring 30. The driving unit 26 operates based on the supplied power or the transmitted command signal, and actuates the clamp mechanism 28. Thus, the clamp mechanism 28 performs a holding operation or a non-holding operation on the workpiece 14.

In the workpiece holding system 10, the whole workpiece holding device 16 that holds the workpiece 14 is exchanged with respect to the base 22 when machining content of the machine tool 12 is changed. Consequently, it is unnecessary to rewire the connection between the control device 18 and the workpiece holding device 16, and it is easy to change arrangements.

### Specific Examples (First to Fourth Examples) of Present Embodiment

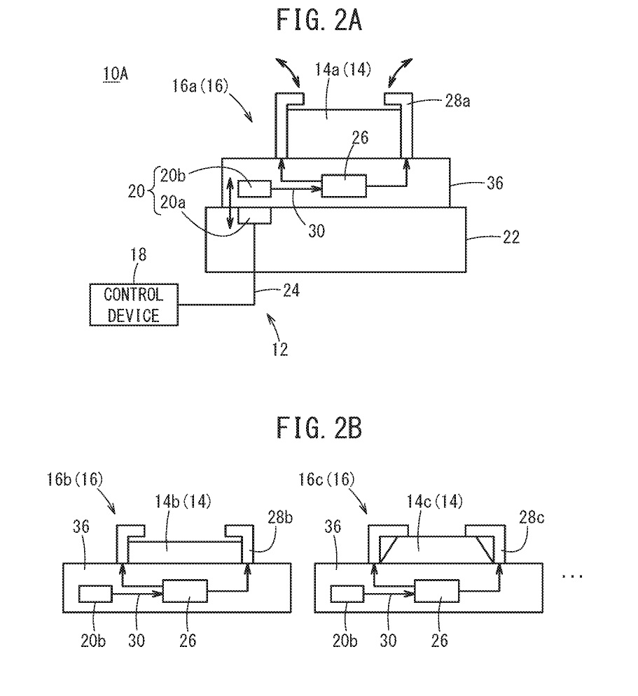

Next, specific examples (first to fourth examples) of the workpiece holding system 10 according to the present embodiment will be described with reference to FIGS. 2A to 5. The same components as those in FIG. 1 will be denoted by the same reference numerals, and will not be described in detail. The same applies hereinafter.

### First Example

First, a workpiece holding system 10A according to the first example will be described with reference to FIGS. 2A and 2B. The first example is a specific example of application to a table (horizontally-placed jig) of the machine tool 12.

The workpiece holding device 16 (first workpiece holding device 16a) shown in FIG. 2A is a device that holds the workpiece 14 (first workpiece 14a). The first workpiece holding device 16a is equipped with a flat-plate-shaped base 36 that is detachably supported on the base 22. A clamp mechanism 28a for holding the first workpiece 14a is provided on the base 36. The driving unit 26 is provided in the base 36.

The second communication unit 20b is provided in the base 36 and is provided at a position that corresponds to the first communication unit 20a in the base 36 when the first workpiece holding device 16a is placed on the base 22. In this case, the first communication unit 20a and the second communication unit 20b are positioned within a range of a distance at which the first communication unit 20a and the second communication unit 20b can perform short-range wireless communication with each other when the first workpiece holding device 16a is placed on the base 22. The clamp mechanism 28a grips and holds side surfaces of the first workpiece 14a of a substantially rectangular shape.

FIG. 2B shows the workpiece holding device 16 (a second workpiece holding device 16b, a third workpiece holding device 16c) that holds another workpiece 14 (a second workpiece 14b, a third workpiece 14c) having different machining content from that of the first workpiece 14a.

Similar to the first workpiece holding device 16a, the second workpiece holding device 16b and the third workpiece holding device 16c include respective flat-plate-shaped bases 36 that are detachably supported on the bases 22. Clamp mechanisms 28b and 28c for holding the second workpiece 14b and the third workpiece 14c respectively are provided on the bases 36. The driving unit 26 and the second communication unit 20b are provided in the base 36 of each of the second workpiece holding device 16b and the third workpiece holding device 16c. The second communication unit 20b is provided at a position that corresponds to the first communication unit 20a in the base 36 when the second workpiece holding device 16b (or the third workpiece holding device 16c) is placed on the base 22.

The second workpiece 14b is a workpiece of a substantially rectangular shape that is thinner than the first workpiece 14a. A clamp mechanism 28b of the second workpiece holding device 16b grips and holds side surfaces of the second workpiece 14b. The third workpiece 14c is a workpiece of a substantially trapezoidal shape that is thinner than the first workpiece 14a. A clamp mechanism 28c of the third workpiece holding device 16c grips and holds an upper surface of the third workpiece 14c.

In the case that the machine tool 12 sequentially performs machining on the first to third workpieces 14a to 14c of different machining content in order, a robot hand or the like (not shown) places, on the base 22, the whole first workpiece holding device 16a with the first workpiece 14a being disposed thereon. In this case, the first workpiece holding device 16a is placed on the base 22 such that the second communication unit 20b is disposed at a position corresponding to the first communication unit 20a.

In this state, the control device 18 supplies power or transmits a command signal for commanding to hold the first workpiece 14a, to the first communication unit 20a via the first wiring 24. The first communication unit 20a performs short-range wireless communication to supply power or transmit the command signal to the second communication unit 20b. The second communication unit 20b outputs the supplied power or transmits the command signal to the driving unit 26 via the second wiring 30. Thus, the driving unit 26 operates based on the supplied power or the transmitted command signal to thereby actuate the clamp mechanism 28a, whereby the first workpiece 14a is held. As a result, the machine tool 12 can perform predetermined machining on the held first workpiece 14a.

When machining of the first workpiece 14a is finished, the control device 18 stops supplying the power to the first workpiece holding device 16a, or transmits the command signal for non-holding of the first workpiece 14a to the first workpiece holding device 16a. The driving unit 26 stops operating in response to stopping of the power supply or based on the transmitted command signal, whereby a holding state of the first workpiece 14a by the clamp mechanism 28a is released. Thereafter, the first workpiece holding device 16a is detached from the base 22 by the robot hand or the like.

Subsequently, the second workpiece holding device 16b and the third workpiece holding device 16c are placed on the bases 22 in this order to perform machining on the second workpiece 14b and the third workpiece 14c in order. Operations in this case are the same as that of the above first workpiece holding device 16a, and therefore will not be described in detail.

In the first example, each of the first to third workpiece holding devices 16a to 16c is attachable and detachable to and from the base 22, and the first communication unit 20a and the second communication unit 20b perform short-range wireless communication with each other. Consequently, wireless connection is established between the base 22 and each of the first to third workpiece holding devices 16a to 16c. Owing thereto, even when machining content is changed, it is possible to change the machining content merely by exchanging the whole workpiece holding device 16 (the first to third workpiece holding devices 16a to 16c) with respect to the base 22, and it is easy to change the arrangements. Further, in the first example, by automatically exchanging the whole first to third workpiece holding devices 16a to 16c by the robot hand or the like, it is possible to reduce the amount of time required for arrangement change, and it is easier to change the arrangements.

### Second Example

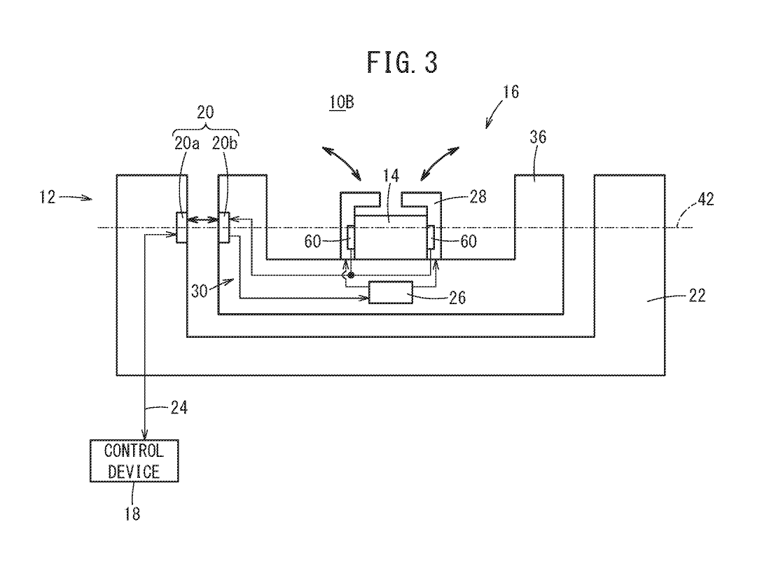

Next, a workpiece holding system 10B according to a second example will be described with reference to FIG. 3. The second example is a specific example of application to the rotary table of the machine tool 12.

In the second example, the base 22 fixed to the machine tool 12 is formed into a substantially U shape. Meanwhile, the base 36 of the workpiece holding device 16 is formed into a substantially U shape. Inside the base 22, the base 36 is supported rotatably about a rotation axis 42 with respect to the base 22 by, for example, a fixing/supporting unit such as a chuck (not shown). Hence, the workpiece holding device 16 is rotated about the rotation axis 42 by a rotation driving source (not shown) provided to the base 22. The fixing/supporting unit is not limited to the chuck or the like. Any type of fixing/supporting unit can be adopted as long as the fixing/supporting unit can support the workpiece holding device 16 rotatably with respect to the base 22.

In the second example, the first communication unit 20a and the second communication unit 20b are arranged within a range of a predetermined distance around the rotation axis 42. Preferably, the first communication unit 20a and the second communication unit 20b are provided on the rotation axis 42. That is, the first communication unit 20a and the second communication unit 20b only need to be positioned within a distance range in which the first communication unit 20a and the second communication unit 20b can perform short-range wireless communication with each other even when the workpiece holding device 16 rotates about the rotation axis 42 with respect to the base 22.

In the second example, when the machining content of the machine tool 12 is changed, the whole workpiece holding device 16 may be exchanged similar to the first example. More specifically, in the second example, operation of the rotation driving source is stopped, and in a state where the workpiece holding device 16 is not rotating, the workpiece holding device 16 is detached from the fixing/supporting unit. Then, another workpiece holding device 16 of different machining content is attached to the fixing/supporting unit. In this case, the control device 18 supplies power or transmits a command signal for a holding operation or a non-holding operation of the workpiece 14, to the workpiece holding device 16 via the communication unit 20. Then, the clamp mechanism 28 performs a holding operation or a non-holding operation with respect to the workpiece 14.

In the second example, detecting units 60 for detecting whether or not the workpiece 14 is held by the clamp mechanism 28 may be provided. The detecting units 60 are detecting units such as pressure sensors or the like provided on contact surfaces of the clamp mechanism 28 that come into contact with the workpiece 14. When the clamp mechanism 28 holds the workpiece 14, each detecting unit 60 detects a pressing force applied from the workpiece 14 to each detecting unit 60, and transmits the detection result to the control device 18 via the second wiring 30, the second communication unit 20b, the first communication unit 20a and the first wiring 24.

The control device 18 checks whether or not the workpiece 14 is held by the clamp mechanism 28, based on the detection result transmitted from each detecting unit 60. For example, the control device 18 can determine that the clamp mechanism 28 holds the workpiece 14 if the pressing force corresponding to the detection result is a predetermined threshold or more.

In the second example, the detecting units 60 are not essential components. Consequently, even when adopting a configuration that does not include any detecting units 60, the workpiece holding system 10B according to the second example can perform a holding operation and a non-holding operation with respect to the workpiece 14.

### Third Example

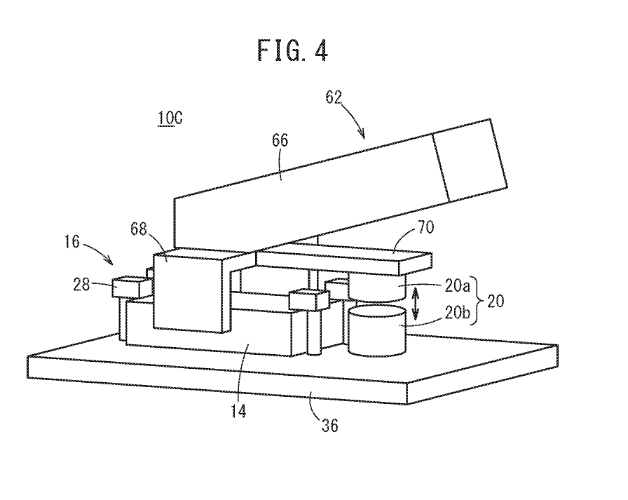

Next, a workpiece holding system 10C according to a third example will be described with reference to FIG. 4. The third example is a modification of the configurations in FIGS. 1 to 3, and is a specific example of application to transfer of the workpiece 14 by an automatic transfer device 62 such as a transfer robot or the like.

In the third example, the automatic transfer device 62 includes an arm portion 66, and a grip portion 68 that is attached to a distal end of the arm portion 66 and can grip the workpiece 14. The arm portion 66 and the grip portion 68 form a robot hand of the transfer robot. The first communication unit 20a is fixed to a plate portion 70 that extends from the grip portion 68. That is, the third example differs from the configurations in FIGS. 1 to 3 in that the first communication unit 20a is provided on the automatic transfer device 62. In this case, a control device (not shown) of the automatic transfer device 62 corresponds to the control device 18 in FIGS. 1 to 3.

In the third example, the workpiece holding device 16 is disposed on the machine tool 12 (see FIGS. 1 to 3). In this case, the second communication unit 20b is provided at a position that corresponds to the first communication unit 20a when the grip portion 68 of the automatic transfer device 62 places the workpiece 14 on the base 36 while gripping the workpiece 14 or the grip portion 68 grips the workpiece 14 placed on the base 36. FIG. 4 does not show the first wiring 24, the driving unit 26 or the second wiring 30.

In the third example, at a time of changing the machining content of the machine tool 12, when the grip portion 68 of the automatic transfer device 62 grips the workpiece 14, the first communication unit 20a and the second communication unit 20b face each other with a gap therebetween. Then, by short-range wireless communication from the first communication unit 20a to the second communication unit 20b, the control device of the automatic transfer device 62 supplies power to the driving unit 26 or transmits the command signal for a non-holding operation of the workpiece 14 to the driving unit 26. Then, the driving unit 26 operates based on the supplied power or the transmitted command signal, and the clamp mechanism 28 releases the holding state of the workpiece 14. Thereafter, while gripping the workpiece 14 in a non-holding state, the grip portion 68 can transfer the workpiece 14 from the workpiece holding device 16.

Next, the grip portion 68 grips another workpiece 14 of different machining content, and places the workpiece 14 at a location inside the clamp mechanism 28 on an upper surface of the base 36. Thus, the first communication unit 20a and the second communication unit 20b face each other with the gap therebetween. Then, the first communication unit 20a performs short-range wireless communication with the second communication unit 20b, and through the wireless communication, the control device of the automatic transfer device 62 supplies power to the driving unit 26 or transmits the command signal for a holding operation of the workpiece 14 to the driving unit 26. The driving unit 26 operates based on the supplied power or the transmitted command signal, and the clamp mechanism 28 holds the workpiece 14. After holding the workpiece 14, the grip portion 68 releases a gripping state of the workpiece 14 and is retracted from the workpiece 14. Consequently, the machine tool 12 can perform machining on another workpiece 14 of the different machining content.

Thus, in the third example, the automatic transfer device 62 supplies power or transmits the command signal to the workpiece holding device 16. Therefore, the machine tool 12 and peripheral devices thereof do not need to prepare a power supply for the workpiece holding device 16.

### Fourth Example

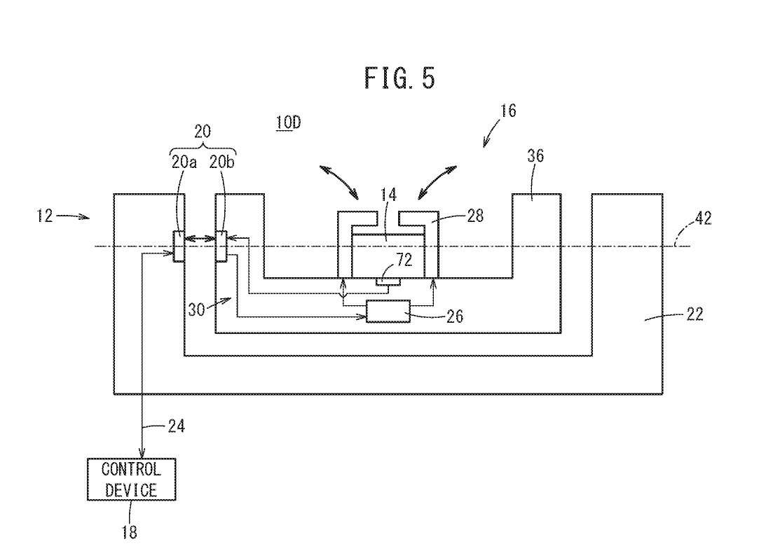

Next, a workpiece holding system 10D according to a fourth example will be described with reference to FIG. 5. The fourth example is a modification of the second example, and differs from the second example in that a detecting unit 72 such as a pressure sensor or the like is provided at a location on the upper surface of the base 36 on which the workpiece 14 is placed. Hence, in the description of the fourth example, only differences with the second example will be described.

In the fourth example, when the workpiece 14 is placed on the upper surface of the base 36, the detecting unit 72 detects a pressing force caused by the own weight of the workpiece 14 and transmits the detection result to the control device 18 via the second wiring 30, the second communication unit 20b, the first communication unit 20a and the first wiring 24. The control device 18 checks whether or not the workpiece 14 is placed on the base 36 based on the detection result transmitted from the detecting unit 72.

If, for example, the pressing force corresponding to the detection result is a predetermined threshold or more, the control device 18 can determine that the workpiece 14 is placed on the upper surface of the base 36. Further, when the power has been supplied to the workpiece holding device 16 or the command signal for a holding operation of the workpiece 14 has been transmitted to the workpiece holding device 16, the control device 18 can determine that the clamp mechanism 28 holds the workpiece 14 in a state where the workpiece 14 is placed on the upper surface of the base 36.

The workpiece holding system 10D according to the fourth example may further include the detecting units 60 according to the second example, in addition to the detecting unit 72. In this case, the control device 18 determines whether or not the workpiece 14 is placed on the upper surface of the base 36 based on the detection result of the detecting unit 72, and determines whether or not the clamp mechanism 28 holds the workpiece 14 based on the detection results of the detecting units 60.

### Effect of Present Embodiment and Each Example

As described above, in the workpiece holding system 10 (10A to 10D) according to the present embodiment, the control device 18 and the workpiece holding device 16 are electrically connected via the communication unit 20 without contacting each other. Owing thereto, in the case that, in order to change the machining content of the machine tool 12, the whole workpiece holding device 16 (first to third workpiece holding devices 16a to 16c) that holds the workpiece 14 (first to third workpieces 14a to 14c) is exchanged, it is unnecessary to rewire the connection, and it is easy to change the arrangements. As a result, the present embodiment is suitably applicable to manufacturing of a wide variety of products in small quantities in which the workpiece holding device 16 must be frequently exchanged.

More specifically, in the first, second and fourth examples, the workpiece holding systems 10A, 10B and 10D each include the base 22 that is fixed to the machine tool 12, and the workpiece holding device 16 (first to third workpiece holding devices 16a to 16c) is attachable and detachable with respect to the base 22. In this case, the communication unit 20 includes the first communication unit 20a that is mounted on the base 22, and the second communication unit 20b that is mounted on the workpiece holding device 16. Supply of power or transmission of a command signal is carried out between the first communication unit 20a and the second communication unit 20b.

Consequently, when the machining content of the machine tool 12 is changed, it is only necessary to exchange the whole workpiece holding device 16 with respect to the base 22. Therefore, it is easy to change the arrangements, and it is possible to reduce man-hours for changing the arrangements. Further, it is unnecessary to rewire the connection, so that it is possible to simplify the first wiring 24 and the second wiring 30.

In this case, in the second example and the fourth example, the workpiece holding device 16 is supported rotatably about the rotation axis 42 by the base 22, and the first communication unit 20a and the second communication unit 20b are provided in the range of a predetermined distance around the rotation axis 42.

Owing thereto, it is possible to continue supplying power or transmitting command signals to the workpiece holding device 16 during rotation of the workpiece holding device 16. Further, since power is supplied or a command signal is transmitted via the first communication unit 20a and the second communication unit 20b, it is possible to install the second wiring 30 between the second communication unit 20b and the driving unit 26 in the workpiece holding device 16. That is, it is possible to attach and use a device equipped with signal lines (e.g., detecting units 60, 72) and a device with power cables (e.g., driving unit 26) to the workpiece holding device 16 that is a rotating object. As a result, it is possible to avoid occurrence of problems such as deterioration of a pressure oil, an operation failure of the workpiece holding device due to wearing of a seal member or leakage of a pressure fluid, or the like as in JP2002-036047A.

In the third example, in the workpiece holding system 10C, the communication unit 20 includes the first communication unit 20a that is mounted on the automatic transfer device 62 for transferring the workpiece 14, and the second communication unit 20b that is mounted on the workpiece holding device 16 disposed in the machine tool 12. Supply of power or transmission of a command signal is carried out between the first communication unit 20a and the second communication unit 20b. Thus, since the automatic transfer device 62 side supplies power or transmits the command signal to the workpiece holding device 16, it is not necessary to provide a power supply (control device 18) for the workpiece holding device 16 on the machine tool 12 side. As a result, reduced wiring is achieved in the machine tool 12 and the peripheral devices thereof.

In the second example and the fourth example, the workpiece holding systems 10B, 10d further include the detecting units 60, 72 for detecting whether or not the workpiece 14 is held by the workpiece holding device 16. The detecting units 60, 72 transmit detection results to the control devices 18 via the communication unit 20. Owing thereto, it is possible to check whether the workpiece 14 is held or not on the control device 18 side.

In the workpiece holding system 10 (10A to 10D), the workpiece holding device 16 includes the clamp mechanism 28 (clamp mechanisms 28a to 28c) for carrying out a holding operation and a non-holding operation of the workpiece 14 (first to third workpieces 14a to 14c), and the driving unit 26 for operating based on the power supplied from the control device 18 or the command signal transmitted from the control device 18 and actuating the clamp mechanism 28. Consequently, it is possible to easily control a holding operation and a non-holding operation of the workpiece 14 (first to third workpieces 14a to 14c) from the control device 18 side.

### Other Modifications

The present invention is not limited to the above embodiment, and can naturally be modified variously without departing from the scope of the present invention.

A case where the control device 18 supplies power or transmits the command signal to the workpiece holding device 16 via the communication unit 20 has been described above. In the present embodiment, at least one of power supply and transmission of the command signal may be performed. That is, the control device 18 is applicable to any of cases: where (1) only supply of power is carried out with respect to the workpiece holding device 16; (2) only transmission of a command signal is carried out with respect to the workpiece holding device 16; and (3) both supply of power and transmission of a command signal are carried out with respect to the workpiece holding device 16.

In the case of (3), when the control device 18 transmits the command signal while the control device 18 supplies power to the driving unit 26, the driving unit 26 operates to thereby cause the clamp mechanism 28 to perform a holding operation or a non-holding operation of the workpiece 14.

In the above description, the cases where the workpiece holding systems 10B, 10D include the detecting units 60 and 72, respectively, have been described in the second example and the fourth example. In the present embodiment, the workpiece holding systems 10A, 10C may include the detecting units 60 or the detecting unit 72 in the first example and the third example. Alternatively, the workpiece holding systems 10A to 10D may include each of the detecting units 60, 72 in all of the examples. In any of the cases, the detecting units 60, 72 can detect whether or not the clamp mechanism 28 holds the workpiece 14 (first to third workpieces 14a to 14c), and the control device 18 or the control device of the automatic transfer device 62 can check whether or not the clamp mechanism 28 holds the workpiece 14. Thus, it is possible to facilitate an operation of changing the arrangements.

In this regard, the control device 18 or the control device of the automatic transfer device 62 can check whether or not the clamp mechanism 28 holds the workpiece 14 based on the detection results of the detecting units 60 and check whether or not the workpiece 14 is placed on the base 36 based on the detection result of the detecting unit 72 as described above. In addition, the control device 18 or the control device of the automatic transfer device 62 can check whether not the clamp mechanism 28 pinches a foreign material. If, for example, a pressing force corresponding to the detection result of the detecting units 60 takes a value that never occurs in normal cases, the control device 18 or the control device of the automatic transfer device 62 can determine that the clamp mechanism 28 holds a workpiece with a foreign material being pinched therebetween. Further, if a pressing force corresponding to the detection result of the detecting unit 72 takes a value that never occurs in normal cases, the control device 18 or the control device of the automatic transfer device 62 can determine that a foreign material is placed inside the clamp mechanism 28.

What is claimed is:

1. A workpiece holding system comprising:
a workpiece holding device configured to hold a workpiece of a machine tool; and
a communication unit configured to perform short-range wireless communication between a control device and the workpiece holding device to thereby perform at least one of supply of power from the control device to the workpiece holding device and transmission of a command signal for a holding operation or a non-holding operation of the workpiece from the control device to the workpiece holding device.

2. The workpiece holding system according to claim 1, further comprising a base fixed to the machine tool, wherein:
the workpiece holding device is attachable and detachable with respect to the base;
the communication unit includes a first communication unit mounted on the base, and a second communication unit mounted on the workpiece holding device; and
at least one of the supply of power and the transmission of the command signal is performed between the first communication unit and the second communication unit.

3. The workpiece holding system according to claim 2, wherein:
the workpiece holding device is supported by the base rotatably about a rotation axis; and
the first communication unit and the second communication unit are provided within a range of a predetermined distance around the rotation axis.

4. The workpiece holding system according to claim 1, wherein:
the workpiece holding device is disposed in the machine tool;
the communication unit includes a first communication unit mounted on an automatic transfer device configured to transfer the workpiece, and a second communication unit mounted on the workpiece holding device; and
at least one of the supply of power and the transmission of the command signal is performed between the first communication unit and the second communication unit.

5. The workpiece holding system according to claim 1, further comprising a detecting unit configured to detect whether or not the workpiece is held by the workpiece holding device,
wherein the detecting unit is configured to transmit a detection result to the control device via the communication unit.

6. The workpiece holding system according to claim 1, wherein the workpiece holding device includes a clamp mechanism configured to perform a holding operation and a non-holding operation of the workpiece, and a driving unit configured to operate based on power supplied from or the command signal transmitted from the control device and actuate the clamp mechanism.
